(19) United States
(12) Patent Application Publication
(10) Pub. No.: US 2026/0253457 A1
(43) Pub. Date: Aug. 27, 2026

(54) INFORMATION NOTIFICATION SYSTEM

(71) Applicant: TOYOTA JIDOSHA KABUSHIKI KAISHA, Toyota-shi (JP)

(72) Inventor: Ryuki HIRONO, Nagoya-shi (JP)

(73) Assignee: TOYOTA JIDOSHA KABUSHIKI KAISHA, Toyota-shi (JP)

(21) Appl. No.: 19/449,879

(22) Filed: Jan. 15, 2026

(30) Foreign Application Priority Data
Feb. 27, 2025 (JP) 2025-030655

(51) Int. Cl. G07C 5/00; B60L 58/12

(52) U.S. Cl. CPC G07C 5/008; B60L 58/12; B60L 2240/70

(57) ABSTRACT

The vehicle includes an auxiliary battery, a controller configured to monitor a remaining electric charge amount of the auxiliary battery and perform power supply cutoff when the remaining electric charge amount reaches a first threshold, and a communication device configured to transmit power supply cutoff information indicating that the power supply cutoff has been performed on the auxiliary battery to the management server. The communication device is configured to transmit the power supply cutoff information for the auxiliary battery to the management server before the remaining electric charge amount reaches the first threshold, and the management server is configured to transmit the power supply cutoff information to the user terminal device.

### CROSS-REFERENCE TO RELATED APPLICATION

This application claims priority to Japanese Patent Application No. 2025-030655 filed on February 27, 2025. The disclosure of the above-identified application, including the specification, drawings, and claims, is incorporated by reference herein in its entirety.

### BACKGROUND

### 1. Technical Field

The present disclosure relates to an information notification system that notifies a user terminal device of information related to a vehicle.

### 2. Description of Related Art

Japanese Unexamined Patent Application Publication No. 2022-181855 (JP 2022-181855 A) discloses a vehicle including an auxiliary load, an auxiliary battery that can charge or discharge auxiliary power, and a relay for an auxiliary battery that switches a connection state or a cutoff state of a power line that connects the auxiliary load and the auxiliary battery. When the power line is in the cutoff state by the relay for an auxiliary battery, power supply from the auxiliary battery to the auxiliary load is stopped, and the auxiliary load cannot be operated.

### SUMMARY

In recent years, a technique has been put into practical use in which a user uses a terminal device, such as a smartphone, to operate a vehicle from a remote location. For example, the user can remotely start an air conditioner in the vehicle using a user terminal device before getting on the vehicle and adjust the in-vehicle temperature such that inside the vehicle is at a comfortable temperature when the user gets on the vehicle.

In a case where the power supply from the auxiliary battery to the auxiliary load of the vehicle is stopped, since a communication device of the vehicle cannot operate, and the vehicle is in a state of communication failure, the user cannot operate the vehicle from the remote location. At this time, the user wants to know the reason why the user cannot operate the vehicle, but since the user terminal device cannot communicate with the vehicle, the user cannot acquire information from the vehicle. Therefore, an object of the present disclosure is to provide a technique for notifying a user terminal device of information related to a vehicle when power supply from an auxiliary battery to an auxiliary load is stopped.

An aspect of the present disclosure relates to an information notification system that notifies a user terminal device of information related to a vehicle via a management server, and the vehicle includes an auxiliary battery, a controller configured to monitor a remaining electric charge amount of the auxiliary battery and perform power supply cutoff when the remaining electric charge amount reaches a first threshold, and a communication device configured to transmit power supply cutoff information indicating that the power supply cutoff has been performed on the auxiliary battery to the management server. The communication device is configured to transmit the power supply cutoff information for the auxiliary battery to the management server before the remaining electric charge amount reaches the first threshold, and the management server is configured to transmit the power supply cutoff information to the user terminal device.

The management server may be configured to transmit the power supply cutoff information to the user terminal device when the user terminal device attempts to communicate with the vehicle via the management server and the vehicle is in a state of communication failure. The controller may be configured to cause the communication device to transmit the power supply cutoff information to the management server when the remaining electric charge amount reaches a second threshold higher than the first threshold. Power supply to the communication device may be stopped when the controller performs the power supply cutoff.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of an information notification system according to an embodiment;

FIG. 2 is a diagram showing a configuration of a vehicle of the embodiment;

FIG. 3 is a diagram showing an example of a flowchart for implementing an information notification method; and

FIG. 4 is a diagram showing another example of the flowchart for implementing the information notification method.

### DETAILED DESCRIPTION OF EMBODIMENTS

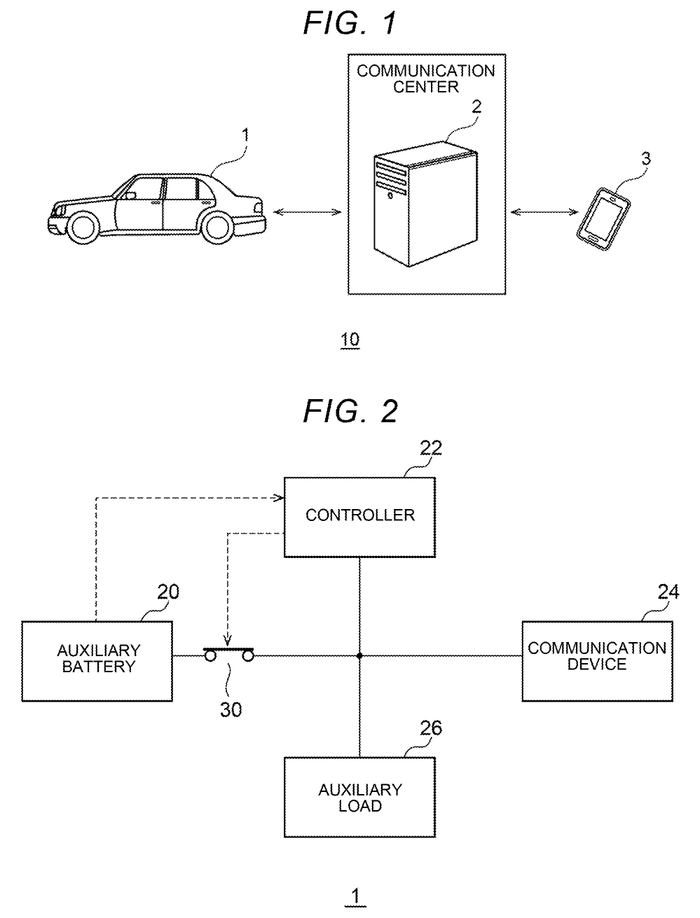

FIG. 1 schematically shows a configuration of an information notification system 10 according to an embodiment. The information notification system 10 is a communication system including a vehicle 1 of a user, a management server 2 installed in a communication center, and a user terminal device 3 owned by the user, and the management server 2 relays the communication between the vehicle 1 and the user terminal device 3. The user terminal device 3 may be a portable terminal device, such as a smartphone or a tablet, operated by the user, or may be a desktop personal computer.

The user terminal device 3 owned by the user has installed an application (hereinafter, referred to as "vehicle operation application") for operating the vehicle 1 of the user, and the user can operate the vehicle 1 from a remote location by using the vehicle operation application. For example, when the user transmits an operation request for the air conditioner of the vehicle 1 from the user terminal device 3 to the management server 2 before getting on the vehicle 1, the management server 2 receives an air conditioner operation request and transmits the air conditioner operation request to the vehicle 1. When the vehicle 1 receives the air conditioner operation request, the vehicle 1 operates the air conditioner and adjusts the in-vehicle temperature such that the in-vehicle temperature is at the set temperature included in the air conditioner operation request. In this way, the user can get on the vehicle 1 adjusted to a comfortable temperature by using the vehicle operation application. The user may use the vehicle operation application to open the power window before getting on the vehicle or set the destination of the navigation system in addition to the remote start of the air conditioner.

FIG. 2 shows a schematic configuration of the vehicle 1 of the embodiment. The vehicle 1 includes an auxiliary battery 20, a controller 22, a communication device 24, and an auxiliary load 26. The auxiliary battery 20 is a battery provided separately from a main battery (not shown) for driving a vehicle, and is used for starting the vehicle 1 and the like. A relay 30 for turning on and off a connection state with the auxiliary battery 20 is provided between the auxiliary battery 20 and the controller 22, the communication device 24, and the auxiliary load 26. The relay 30 may be built in the auxiliary battery 20. When the controller 22, the communication device 24, and the auxiliary load 26 are in the connection state with the auxiliary battery 20, the controller 22, the communication device 24, and the auxiliary load 26 can operate by receiving the power supply from the auxiliary battery 20. On the other hand, when the relay 30 is turned off (cut off) and the power supply from the auxiliary battery 20 is stopped, the controller 22, the communication device 24, and the auxiliary load 26 cannot operate.

The vehicle 1 of the embodiment may be an electrified vehicle that uses an electric motor as a traveling drive power source. A main battery (not shown) for driving is a lithium ion secondary battery. The main battery for driving can discharge the high-voltage power (for example, power from several tens of volts to several hundreds of volts) that drives the electric motor of the vehicle 1, or can charge the high-voltage power generated by the electric motor. The electrified vehicle may be, for example, a battery electric vehicle (BEV), a hybrid electric vehicle (HEV), a plug-in hybrid electric vehicle (PHEV), a fuel cell electric vehicle (FCEV), or the like. The vehicle 1 may be a vehicle driven by a driver or may be an autonomous driving vehicle.

The auxiliary load 26 may include an auxiliary needed for starting the vehicle 1 and an auxiliary not used for starting the vehicle 1. The auxiliary needed for starting the vehicle 1 includes a DC-DC converter or an inverter connected to the battery for driving, and the controller 22 is one of the auxiliaries needed for starting the vehicle 1. The auxiliary not used for starting the vehicle 1 includes a light, such as a headlight, and a power window, and the communication device 24 that communicates with an external communication center is one of the auxiliaries not used for starting the vehicle 1.

The controller 22 is configured by at least one electronic control unit (ECU). The ECU includes a central processing unit (CPU) and a memory including a random access memory (RAM) and a read only memory (ROM). The CPU executes a process that is predetermined according to a program stored in the memory by using data stored in the memory or data from the outside.

The auxiliary battery 20 is, for example, a lithium ion secondary battery, and can charge or discharge a low-voltage power (for example, about 12 V) that operates the controller 22, the communication device 24, and the auxiliary load 26. The auxiliary battery 20 includes a measurement unit that measures a voltage, a state of charge (SOC), and the like of the auxiliary battery 20 and transmits a sensor signal indicating a measured value, such as the measured voltage and SOC, to the controller 22.

The controller 22 monitors the remaining electric charge amount (charge amount) of the auxiliary battery 20 from the transmitted measured value. In normal power management, when the remaining electric charge amount of the auxiliary battery 20 decreases to be equal to or lower than a value that is predetermined, the controller 22 controls the DC-DC converter connected to the battery for driving to charge the auxiliary battery 20.

However, in a case where the vehicle 1 is faulty or in a case where the user places the vehicle 1 without driving the vehicle 1 for a long period, a situation may occur in which the auxiliary battery 20 cannot be charged. In a case where the auxiliary battery 20 cannot be charged, the controller 22 turns off (cuts off) the relay 30 and performs the power supply cutoff of the auxiliary battery 20 when the remaining electric charge amount reaches a first threshold that is predetermined. Then, the power supply from the auxiliary battery 20 to the controller 22, the communication device 24, and the auxiliary load 26 is stopped. When the power supply cutoff is performed, the controller 22, the communication device 24, and the auxiliary load 26 cannot operate. The first threshold is a threshold set for the power supply cutoff, and is preferably set to a value higher than a voltage value or an SOC value at which the power supply from the auxiliary battery 20 is completely disabled.

Therefore, even when the user attempts to operate the vehicle 1 by using the vehicle operation application after the power supply cutoff, since the communication function of the vehicle 1 is not operated, the communication cannot be established between the management server 2 and the vehicle 1 in the communication center. At this time, the management server 2 can notify the user terminal device 3 that the communication with the vehicle 1 cannot be performed, but the user cannot know the reason why the communication of the vehicle 1 owned by the user cannot be performed even when the user receives the notification. Therefore, in the information notification system 10 of the embodiment, a mechanism for notifying the user that a state of the power supply cutoff is performed is implemented.

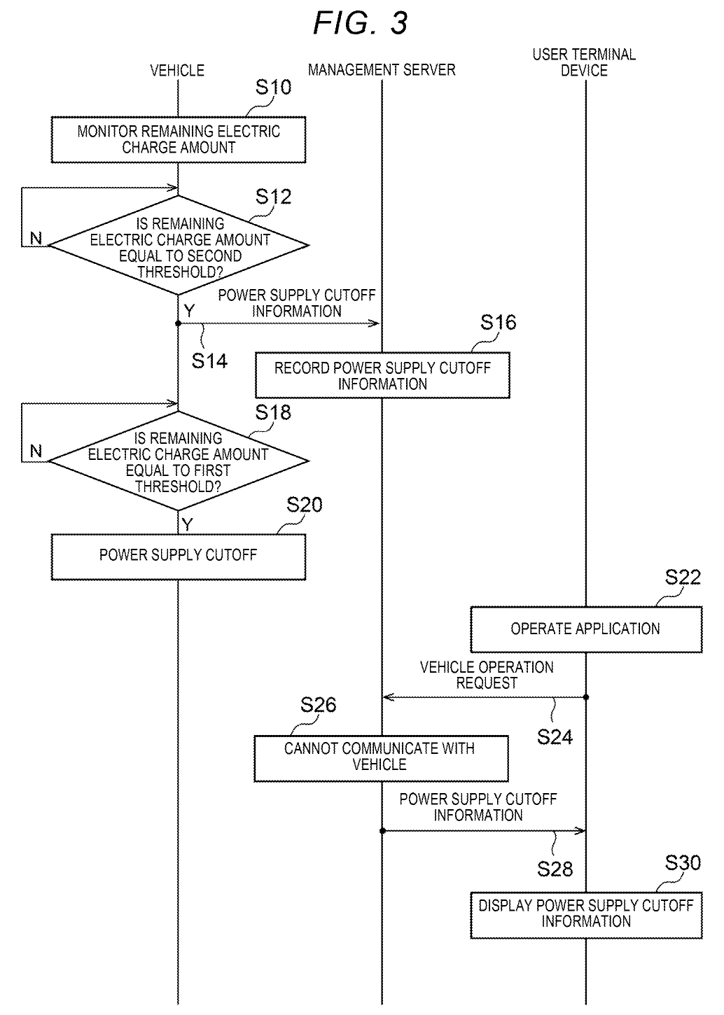

FIG. 3 shows an example of a flowchart for implementing an information notification method according to the embodiment. In the vehicle 1, the controller 22 monitors the remaining electric charge amount of the auxiliary battery 20 (S10). The controller 22 may monitor the remaining electric charge amount based on the voltage or the SOC of the auxiliary battery 20. The controller 22 determines whether the remaining electric charge amount of the auxiliary battery 20 has reached a second threshold that is predetermined (S12). In a case where the remaining electric charge amount is greater than the second threshold (N in S12), the controller 22 continues to monitor the remaining electric charge amount. Here, the second threshold is set to a value higher than the first threshold set for the power supply cutoff.

When the remaining electric charge amount of the auxiliary battery 20 reaches the second threshold (Y in S12), the controller 22 causes the communication device 24 to transmit the power supply cutoff information indicating that the power supply cutoff has been performed on the auxiliary battery 20 to the management server 2 (S14). Since the second threshold is set to the value higher than the first threshold set for the power supply cutoff, the controller 22 does not perform the power supply cutoff of the auxiliary battery 20 at this time. That is, the communication device 24 transmits the power supply cutoff information for the auxiliary battery 20 to the management server 2 before the remaining electric charge amount reaches the first threshold and the power supply cutoff is performed. When the management server 2 receives the power supply cutoff information, the management server 2 records the power supply cutoff information in a memory (not shown) in association with information (vehicle ID) for identifying the vehicle 1 (S16).

The controller 22 monitors the remaining electric charge amount of the auxiliary battery 20 until the remaining electric charge amount of the auxiliary battery 20 reaches a first threshold that is predetermined (N in S18). When the remaining electric charge amount of the auxiliary battery 20 reaches the first threshold (Y in S18), the controller 22 turns off the relay 30 to perform the power supply cutoff, and stops the power supply from the auxiliary battery 20 to the auxiliary (S20). As a result, the vehicle 1 is in a state of communication failure with the management server 2.

Thereafter, the user operates the vehicle operation application of the user terminal device 3 (S22), and transmits a vehicle operation request to the management server 2 (S24). The vehicle operation request may be, for example, a request to operate the air conditioner of the vehicle 1. When the management server 2 receives the air conditioner operation request, the management server 2 searches for the vehicle 1 having the vehicle ID included in the air conditioner operation request, but since the vehicle 1 is in the state of communication failure, the management server 2 cannot communicate with the vehicle 1 (S26). Therefore, the management server 2 transmits the recorded power supply cutoff information to the user terminal device 3 as a response to the vehicle operation request (S28), and the user terminal device 3 displays the information indicating that the power supply cutoff has been performed in the vehicle 1 on the display screen (S30). As a result, the user can recognize that the power supply is cut off in the vehicle 1. In a case where the user terminal device 3 attempts to communicate with the vehicle 1 via the management server 2 in this way, it is assumed that the vehicle 1 is in a state of communication failure. In this case, the management server 2 transmits the power supply cutoff information to the user terminal device 3, and the user can know the reason why the user cannot operate the vehicle.

When the vehicle operation request is transmitted to the management server 2 (S24), it is assumed that the power supply cutoff is not performed in the vehicle 1. In this case, since the communication function in the vehicle 1 can be operated, the management server 2 may establish the communication with the vehicle 1 and transmit the vehicle operation request to the vehicle 1.

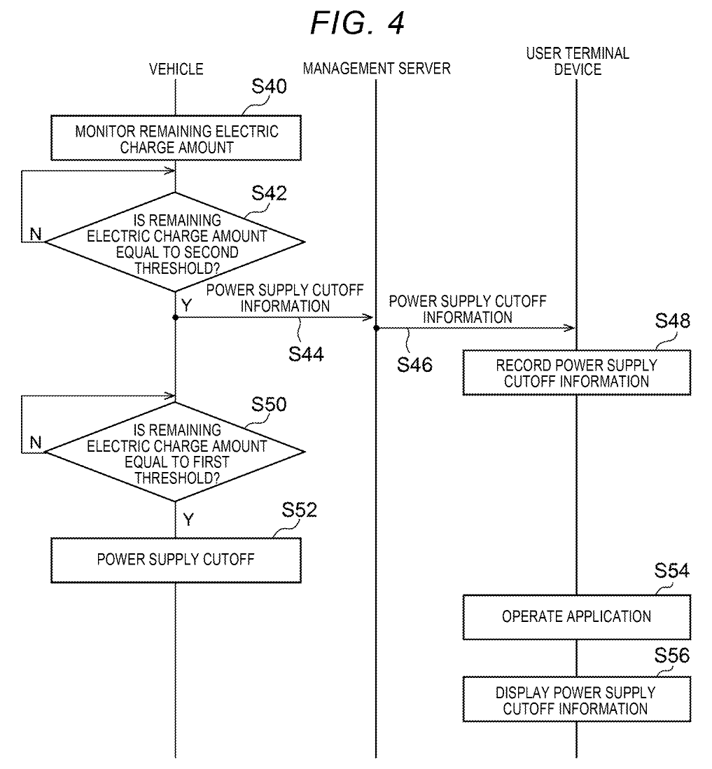

FIG. 4 shows another example of the flowchart for implementing the information notification method according to the embodiment. The controller 22 monitors the remaining electric charge amount of the auxiliary battery 20 (S40), and determines whether the remaining electric charge amount of the auxiliary battery 20 has reached a second threshold that is predetermined (S42). In a case where the remaining electric charge amount is greater than the second threshold (N in S42), the controller 22 continues to monitor the remaining electric charge amount.

When the remaining electric charge amount of the auxiliary battery 20 reaches the second threshold (Y in S42), the controller 22 causes the communication device 24 to transmit the power supply cutoff information indicating that the power supply cutoff has been performed on the auxiliary battery 20 to the management server 2 (S44). Since the second threshold is set to the value higher than the first threshold set for the power supply cutoff, the controller 22 does not perform the power supply cutoff of the auxiliary battery 20 at this time. That is, the communication device 24 transmits the power supply cutoff information for the auxiliary battery 20 to the management server 2 before the remaining electric charge amount reaches the first threshold and the power supply cutoff is performed. When the management server 2 receives the power supply cutoff information, the management server 2 transmits the power supply cutoff information to the user terminal device 3 (S46). When the user terminal device 3 receives the power supply cutoff information, the user terminal device 3 records the power supply cutoff information in a memory (not shown) (S48).

The controller 22 monitors the remaining electric charge amount of the auxiliary battery 20 until the remaining electric charge amount of the auxiliary battery 20 reaches a first threshold that is predetermined (N in S50). When the remaining electric charge amount of the auxiliary battery 20 reaches the first threshold (Y in S50), the controller 22 cuts off the relay 30 to perform the power supply cutoff, and stops the power supply from the auxiliary battery 20 to the auxiliary (S52). As a result, the vehicle 1 is in a state of communication failure with the management server 2.

Thereafter, the user operates the vehicle operation application on the user terminal device 3 (S54). Then, the user terminal device 3 reads the recorded power supply cutoff information from the memory and displays the information indicating that the power supply cutoff has been performed in the vehicle 1 on the display screen (S56). The user terminal device 3 may transmit the vehicle operation request to the management server 2 in response to the application operation by the user, and may read the power supply cutoff information from the memory and display the power supply cutoff information on the display screen when the user terminal device 3 receives the notification indicating that the communication with the vehicle 1 cannot be performed from the management server 2. The user can recognize that the power supply is cut off in the vehicle 1 by displaying the power supply cutoff information.

The present disclosure has been described above based on the embodiments. It should be noted that the embodiments are merely an example, and it is understood by those skilled in the art that various modifications can be made to the combination of each of the components and each of processes thereof, and that such modifications are also within the scope of the present disclosure.

In the embodiment, the remaining electric charge amount of the auxiliary battery 20 reaches the first threshold. Then, the controller 22 performs the power supply cutoff of the auxiliary battery 20, and the communication function of the vehicle 1 cannot be operated, and the vehicle 1 cannot communicate with the management server 2, as described above. In the modification, the communication device 24 has a dedicated battery, and the communication device 24 maintains a state in which the communication device 24 can operate even after the power supply cutoff of the auxiliary battery 20 is performed. In the modification, when the remaining electric charge amount of the auxiliary battery 20 reaches the second threshold, the communication device 24 receives the power supply cutoff information from the controller 22 and records the power supply cutoff information in the memory (not shown). After the remaining electric charge amount of the auxiliary battery 20 reaches the first threshold and the power supply cutoff of the auxiliary battery 20 is performed, the communication device 24 receives the vehicle operation request from the management server 2. Then, the power supply cutoff information may be transmitted to the management server 2 as a response, and the management server 2 may transmit the power supply cutoff information to the user terminal device 3.

What is claimed is:

1. An information notification system that notifies a user terminal device of information related to a vehicle via a management server, wherein:
the vehicle includes
an auxiliary battery,
a controller configured to monitor a remaining electric charge amount of the auxiliary battery and perform power supply cutoff when the remaining electric charge amount reaches a first threshold, and
a communication device configured to transmit power supply cutoff information indicating that the power supply cutoff has been performed on the auxiliary battery to the management server;
the communication device is configured to transmit the power supply cutoff information for the auxiliary battery to the management server before the remaining electric charge amount reaches the first threshold; and
the management server is configured to transmit the power supply cutoff information to the user terminal device.

2. The information notification system according to claim 1, wherein the management server is configured to transmit the power supply cutoff information to the user terminal device when the user terminal device attempts to communicate with the vehicle via the management server and the vehicle is in a state of communication failure.

3. The information notification system according to claim 1, wherein the controller is configured to cause the communication device to transmit the power supply cutoff information to the management server when the remaining electric charge amount reaches a second threshold higher than the first threshold.

4. The information notification system according to claim 1, wherein power supply to the communication device is stopped when the controller performs the power supply cutoff.
